(19) United States
(12) Patent Application Publication
(10) Pub. No.: US 2022/0379440 A1
(43) Pub. Date: Dec. 1, 2022

(54) YOKE INSTALLATION AND REMOVAL ASSISTING DEVICE

(71) Applicants: Sebastian Vlad POPA, Edmonton (CA); Gareth MACHIN, Westerose (CA)

(72) Inventors: Sebastian Vlad POPA, Edmonton (CA); Gareth MACHIN, Westerose (CA)

(21) Appl. No.: 17/334,943

(22) Filed: May 31, 2021

(51) Int. Cl. B25B 13/46; B25B 13/50

(52) U.S. Cl. CPC B25B 13/46; B25B 13/50

(57) ABSTRACT

A yoke installation and removal assisting device includes a structural body, a pair of yoke-receiving channels, a tool-receiving recess, and a pin-receiving channel. The pair of yoke-receiving channels terminally traverses into the structural body at a first end and is used to position a yoke. To prevent slipping during operation, a safety pin is preferably inserted through the pin-receiving channel and a pair of pin holes of the yoke. The pin-receiving channel laterally traverses into the structural body perpendicular to the pair of yoke-receiving channels and is used to hold the yoke against the structural body. The tool-receiving recess traverses into the structural body at a second end and is used to connect to an air tool or a manual ratchet. By operating the air tool/manual ratchet the yoke positioned within the structural body can be installed/removed.

### FIELD OF THE INVENTION

The present invention relates generally to the yoke assemblies, specifically to the installation and removal of yoke assemblies, more specifically to the installation and removal of brake yoke assemblies.

### BACKGROUND

Yoke installation and removal can be a time-consuming task due to a variety of reasons. Corrosion of connected components, limited accessibility to the yoke, and the inability to use an air tool are some of the notable reasons.

U.S. Pat. No. 8,763,224B2 discloses a pinion disassembly tool and method. The device utilizes a yoke holding plate that is sized to receive a socket wrench. The device has an overall planar shape and includes fastener apertures to connect with the yoke. The prior art describes a plate that is connected to a yoke with fasteners and can be used to remove a pinion. The prior art specifically focuses on disassembly. The use of an air tool and using a safety pin during operation are not described in this patent.

KR20130062497A discloses a cam yoke assembling system. In addition to being utilized for cam yoke assembling, a rotation restoring force generated by a torsion spring of the system can be used to compensate for the clearance between the support cam and a yoke plug. This disclosure does not focus on installing or removing a brake yoke assembly.

U.S. Pat. No. 2,239,192A describes a yoke and shaft assembly. In particular, the prior art describes an assembly that can be used to connect with a driving shaft and a universal joint yoke member. The assembly may be used to protect operational components from dirt and other external material. This patent does not describe a system and method of installing/removing a yoke. Furthermore, the patent does not describe having safety features such as a safety pin.

U.S. Pat. No. 5,220,716A describes a tool used to disassemble a universal joint with a first yoke and a second yoke. A pulling motion and a pushing motion are exerted in opposite directions to remove either the first yoke or the second yoke. The tool utilizes a cylinder/piston combination for disassembly purposes. The patent does not describe a process of being used for installation purposes. Moreover, the use of air tools and safety features are also not described in this patent.

U.S. Pat. No. 5,966,792A describes a tool for assembling and disassembling a universal joint. In doing so, the tool of the prior art utilizes two relatively movable components that move between two positions using a threaded screw. Furthermore, the prior art utilizes a guide pin during the assembly and disassembly process. The overall components used and the arrangement of the components are different in the prior art. Moreover, the ability to use an impact wrench is not specifically described in this patent.

KR20100006968U describes a device for assembling a pinion shaft for a differential device. The device may be used to prevent interference with the propeller shaft. This document does not describe a process of installing or removing a yoke with power tools or a manual ratchet. Furthermore, safety features are not described in the document.

U.S. Pat. No. 6,907,667B2 describes a method of assembling a portion of a universal joint such as a cross and a yoke. The method includes the steps of positioning a threaded fastener through an aperture, positioning the cross relative to the yoke, and installing a set of bearings. The patent does not describe a removal process or safety measures.

CN102360680A describes an assembly tool for a magnetic yoke which mainly comprises a connecting plate and a set of attaching plates. Each of the set of attaching plates is mounted to the connecting plate such that the overall assembly efficiency is improved and the overall cost is reduced. The document utilizes multiple components for assembly purposes. Furthermore, the document does not describe a possibility to be used with air tools and manual ratchets.

U.S. Pat. No. 9,010,208B2 describes a yoke assembly adapted for use in a rack and pinion steering gear assembly. The yoke assembly includes a yoke bearing, a spring, a yoke cover, and an automatic-adjusting mechanism. During vehicle operation, the automatic-adjusting mechanism and the spring are used to apply a biasing force against the yoke bearing. The patent does not specifically describe a tool that is used in installing and/or removing a yoke.

All documents cited here are incorporated by reference.

None of the above cited documents, alone or in combination disclose a comparable component arrangement to the currently disclosed embodiments of the present invention. Hence there remains need for a yoke installation and removal assisting device that allows the user to safely use an air tool or a manual tool on brake yoke assemblies.

### BRIEF SUMMARY

It is an object of the invention to provide a yoke installation and removal assisting device.

In accordance with an aspect of the invention there is provided a yoke installation and removal assisting device, said device comprising: a structural body, said structural body having a length extending between a first end and a second end; a pair of yoke-receiving channels traversing into said structural body at said first end and partially traverses through said length of said structural body; and a tool-receiving recess centrally traversing into said structural body at said second end, wherein said structural body is rotated to remove or install said yoke.

In accordance with another aspect of the invention there is provided a method of installing or removing a yoke using the device as described above, said method comprising the steps of: inserting a yoke into said pair of yoke-receiving channels, connecting an installation/removal tool to said structural body at said tool-receiving recess; concentrically aligning said pin-receiving channel with a pair of pin holes of the yoke; slidably positioning a safety pin into said pin-receiving channel and through said pair of pin holes to connect said yoke and structural body; and activating said installation/removal tool to rotate said structural body and said yoke.

The advantages and features of the present invention will become better understood with reference to the following more detailed description and claims taken in conjunction with the accompanying drawings in which like elements are identified with like symbols.

To easily identify the discussion of any particular element or act, the most significant digit or digits in a reference number refer to the figure number in which that element is first introduced.

### BRIEF DESCRIPTION OF THE SEVERAL VIEWS OF THE DRAWINGS

FIG. 1 is a perspective view of the yoke installation and removal assisting device of the present disclosure.

FIG. 2A is a photograph illustrating a perspective view of the yoke installation and removal assisting device, wherein a pair of yoke-receiving channels is shown.

FIG. 2B is a top cross-sectional view illustrating the pair of yoke-receiving channels and a pin-receiving channel.

FIG. 2C is a side cross-sectional view illustrating the pair of yoke-receiving channels, the pin-receiving channel, and a tool-receiving recess.

FIG. 3 is a top view of the yoke installation and removal assisting device of the present disclosure.

FIG. 4 is a first side view of the yoke installation and removal assisting device of the present disclosure.

FIG. 5 is a second side view of the yoke installation and removal assisting device of the present disclosure.

FIG. 6 is a perspective view illustrating a negative space within the yoke installation and removal assisting device.

FIG. 7 is a front view illustrating the negative space within the yoke installation and removal assisting device.

FIG. 8 is a side view illustrating the negative space within the yoke installation and removal assisting device.

FIG. 9 is a top view illustrating the negative space within the yoke installation and removal assisting device.

FIG. 10 is a photograph illustrating a yoke and the yoke installation and removal assisting device.

FIG. 11 is a photograph illustrating the yoke and the yoke installation and removal assisting device, wherein the yoke is inserted into the pair of yoke-receiving channels.

FIG. 12 is a photograph illustrating a yoke and the yoke installation and removal assisting device.

FIG. 13 is a photograph illustrating the yoke and the yoke installation and removal assisting device, wherein the yoke is inserted into the pair of yoke-receiving channels.

FIG. 14 is a photograph illustrating an installation/removal tool being attached to the structural body.

### DETAILED DESCRIPTION

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

The present disclosure describes a yoke installation and removal assisting device that may be used with a manual ratchet or an air tool. By utilizing the device described in the present disclosure, a yoke can be installed or removed regardless of the condition of the components or the positioning of the yoke. As a result, the overall time required for installing or removing a yoke may be significantly reduced.

The yoke installation and removal assisting device includes a structural body and a safety pin. The yoke that needs to be installed or removed is positioned into a pair of yoke-receiving channels that traverses the structural body of an embodiment of the invention as disclosed herein. The safety pin, which is inserted into the structural body perpendicular to the yoke, may be used prevent the yoke from slipping during the installation process and/or the removal process. When the yoke and the structural body are secure, an impact wrench or air tool may be connected to a terminal end of the structural body. The structural body and the pair of yoke-receiving channels may be configured to receive all yoke types. Furthermore, the safety pin may also be sized to fit different yoke types.

The embodiments of the invention as described herein relate to a yoke installation and removal assisting device that may be used with a manual ratchet or an impact wrench. By utilizing the device of the present disclosure, a user may install or remove a yoke with convenience regardless of the status of the components or the accessibility to the components. For example, if a corroded yoke cannot be removed manually, the device of the present disclosure may be used with an impact wrench to remove the corroded yoke.

Normally access is limited so a larger tool that would deliver more torque is not feasible. The various embodiments of the brake yoke tool disclosed herein allows use of powered tool and delivery of torque to confined area. Established disassembly and reassembly procedures are by hand tools only. Hence, enabling the device and procedure to be done with the assistance of power tools is greatly advantageous in both speed, efficacy and safety.

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

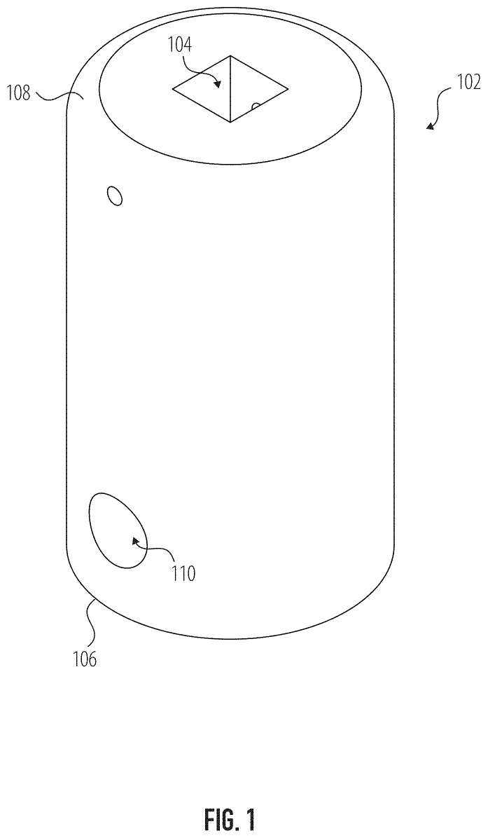

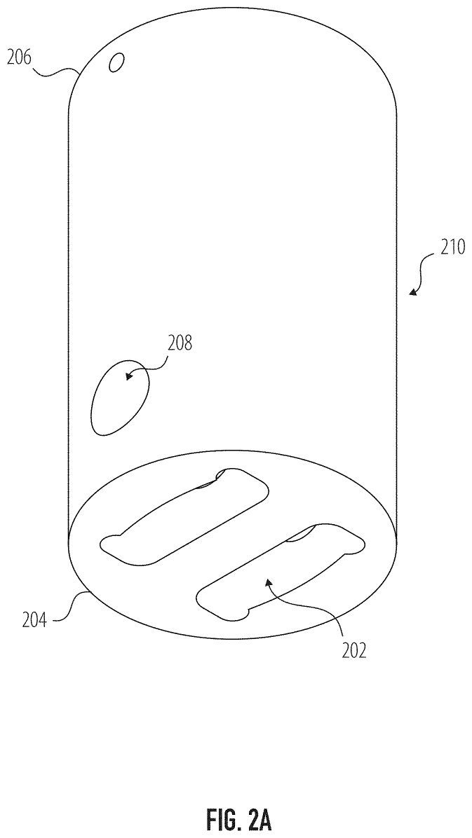

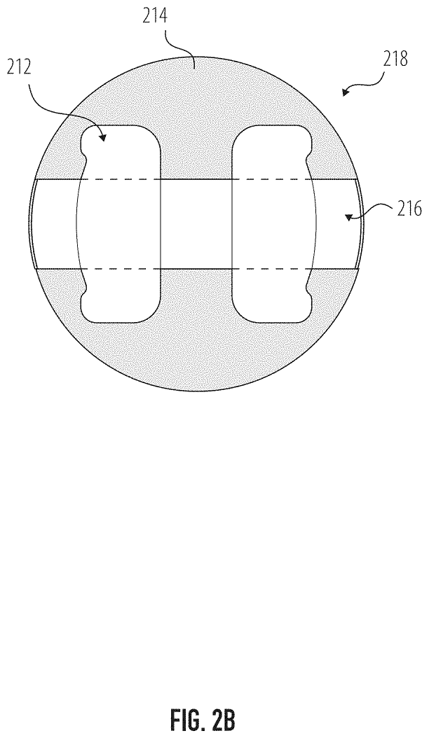

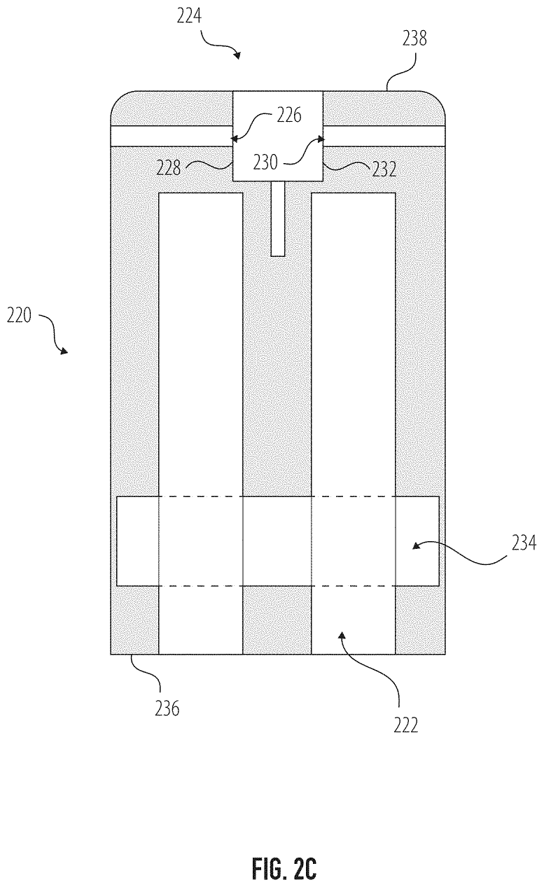

FIG. 1 and FIG. 2A illustrate a perspective view of the yoke installation and removal assisting device of the present disclosure. As seen in FIG. 1 and FIG. 2A, the yoke installation and removal assisting device comprises a structural body 102, a pair of yoke-receiving channels 202, and a tool-receiving recess 104. As seen in FIG. 1, the structural body 102, which is cylindrical in shape in a preferred embodiment, extends from a first end 106 to a second end 108. A length between the first end 106 and the second end 108 can vary in different embodiments. More specifically, the length between the first end 106 and the second end 108 can vary according to a length of the yoke which needs to be installed or removed.

Further referring to FIG. 1, the tool-receiving recess 104 centrally traverses into the structural body 102 at the second end 108. The tool-receiving recess 104, which is cubical in shape in a preferred embodiment, is used to connect to a yoke installation/removal tool. In particular, the positioning and shape of the tool-receiving recess 104 allows the user to connect an impact wrench or a manual ratchet for installation and removal processes.

As seen in FIG. 2A, the pair of yoke-receiving channels 202 traverses into the structural body 102 at the first end 106. In a preferred embodiment, as seen in FIG. 2B, an overall cross-section of each of the pair of yoke-receiving channels 202 is rectangular in shape. However, to receive a wide variety of yokes, the overall cross-section of each of the pair of yoke-receiving channels 202 can be different in other embodiments of the present disclosure. To position the yoke within the structural body 102, as seen in FIG. 2C, the pair of yoke-receiving channels 202 partially traverses through a length of the structural body 102, wherein the length of the structural body 102 extends from the first end 106 to the second end 108. The tool-receiving recess 104 comprises a first engagement cavity 204, and a second engagement cavity 208 and opposing first lateral surface 206 and a second lateral surface 210. To receive yokes of different lengths, an overall depth of the pair of yoke-receiving channels 202 of FIG. 2A can vary in embodiments of the present disclosure. Furthermore, a distance between each of the pair of yoke-receiving channels 202 can also vary in different embodiments of the present disclosure. For example, if the yoke installation and removal device is used with a wide yoke, a channel gap between each of the pair of yoke-receiving channels 202 will be greater than a channel gap when the yoke installation and removal device is used with a narrower yoke.

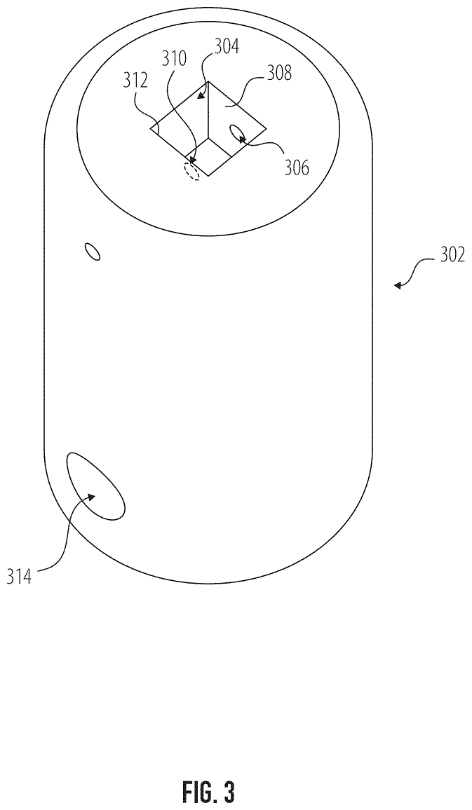

FIG. 3 is a top perspective view illustrating the tool-receiving recess 104 of the present disclosure. To establish a secure connection with an installation/removal tool, which can be, but is not limited to, an impact wrench or a manual ratchet, the tool-receiving recess 104 comprises a first engagement cavity 204, and the second engagement cavity 208. More specifically, the first engagement cavity 204 and the second engagement cavity 208 may be used to engage with a spring-loaded locking detent mechanism of the installation/removal tool. The first engagement cavity 204 traverses into a first lateral surface 206 of the tool-receiving recess 104 which is cubical in shape. The second engagement cavity 208 traverses into a second lateral surface 210 of the tool-receiving recess 104, wherein the first lateral surface 206 and the second lateral surface 210 are positioned opposite to each other. As seen in FIG. 2C, to apply a force along a central axis of the structural body 102, the tool-receiving recesses 104 centrally traverses into the structural body 102 at the second end 108.

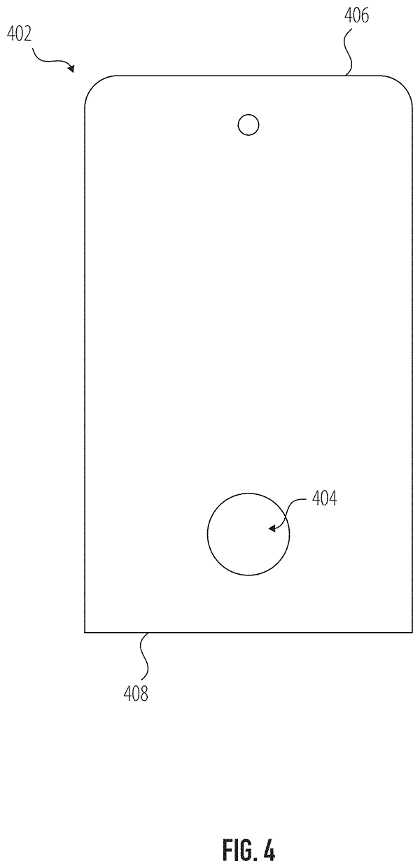

As seen in FIG. 4, the yoke installation and removal assisting device further comprises a pin-receiving channel 110 which laterally traverses through the structural body adjacent the first end 106, wherein the pin-receiving channel 110 is positioned perpendicular to the pair of yoke-receiving channels 202 seen in FIG. 2A. When the yoke is inserted into the pair of yoke-receiving channels 202 of FIG. 2A, a safety pin is preferably positioned into the pin-receiving channel 110 such that the yoke is held against the structural body 102 to prevent the yoke from slipping during installation or removal. Preferably, a locking mechanism is used to secure the safety pin within the pin-receiving channel 110. The locking mechanism may be, but is not limited to, a spring-loaded locking detent mechanism or a magnetic locking mechanism.

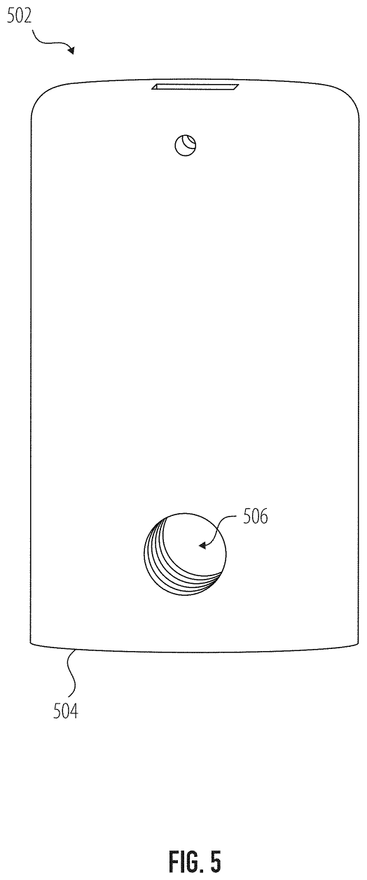

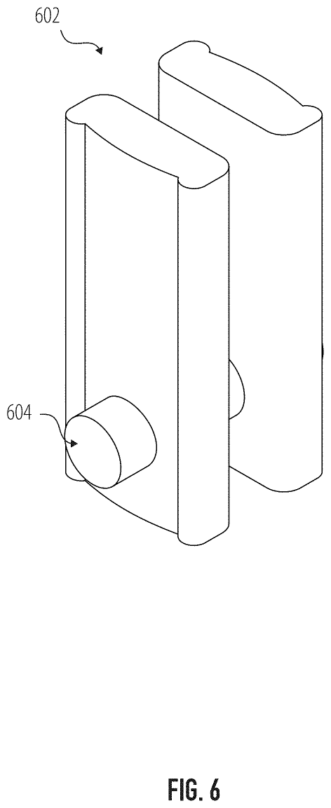

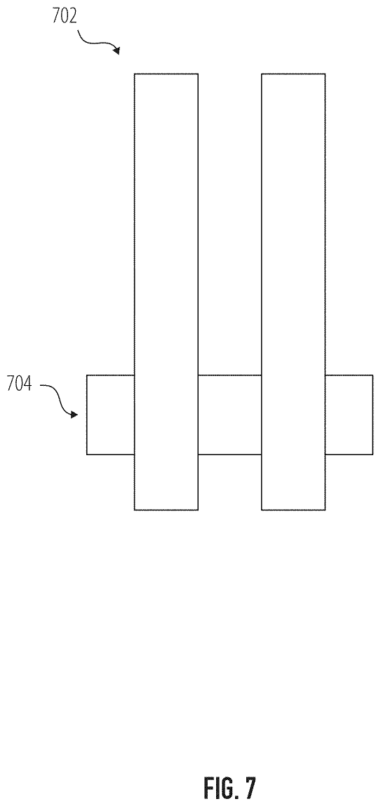

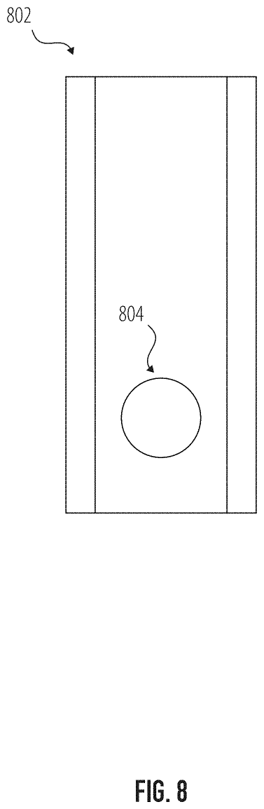

As seen in FIG. 5, FIG. 6, FIG. 7, and FIG. 8, in a preferred embodiment, a cross-section of the pin-receiving channel 110 is circular in shape. Therefore, if a safety pin is used during installation or removal of the yoke, the pin-receiving channel 110 is concentrically aligned with a pin hole of the yoke creating a channel for the safety pin. Even though a circular cross-section is preferred for the pin and the pin-receiving channel 110, in other embodiments, a hexagonal cross-section or other comparable shape may also be used for the pin and the pin-receiving channel 110. In a preferred embodiment, a diameter of the pin-receiving channel 110 seen in FIG. 5 may be within a range of 0.25-1.00 inches.

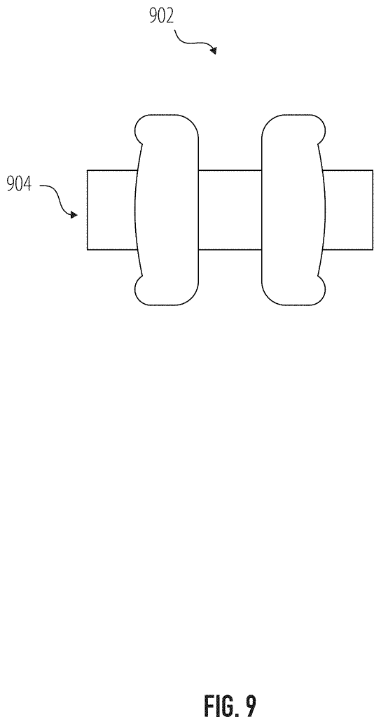

FIG. 9 is another illustration of the pin-receiving channel 110 intersecting the pair of yoke-receiving channels 202. When the yoke is inserted into the pair of yoke-receiving channels 110 of FIGS. 2A, 2B and 2C, a safety pin is preferably positioned into the pin-receiving channel 110 such that the yoke is held against the structural body 102 to prevent the yoke from slipping during installation or removal.

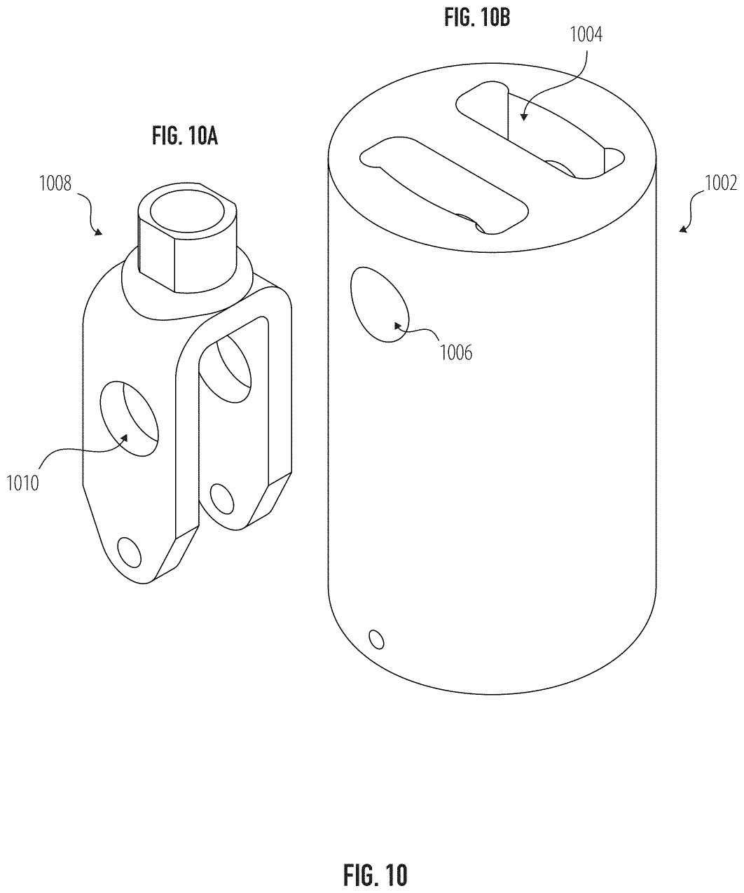

FIG. 10 illustrates the yoke 1002 having a pair of pin holes 1004. The structural body 102, having a pair of yoke-receiving channels 202, and a pin-receiving channel 110. In a method of installing or removing a yoke using the device of the present disclosure, as an initial step, the yoke is inserted into the pair of yoke-receiving channels 202 of FIG. 10. In this specific embodiment, for durability purposes, the structural body 102, seen in FIG. 10 is manufactured from tool steel. However, in other embodiments, the structural body 102 may also be manufactured from material that may be, but is not limited to, carbon fiber or aluminum.

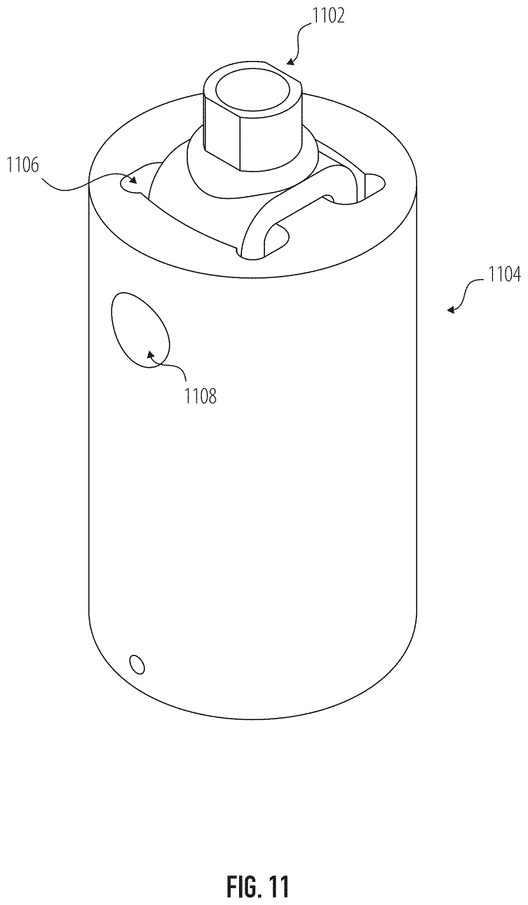

FIG. 11 is an illustration of when the yoke 1002 is inserted into the pair of yoke-receiving channels 202, wherein the yoke 1002 is inserted such that a pair of pin holes 1004 of the yoke 1002, seen in FIG. 10, is concentrically aligned with the pin-receiving channel 110. If a safety pin is used, the safety pin may be inserted into the pin-receiving channel 110 such that the safety pin, the pin-receiving channel 110, and the pair of pin holes 1004 are concentrically aligned to each other.

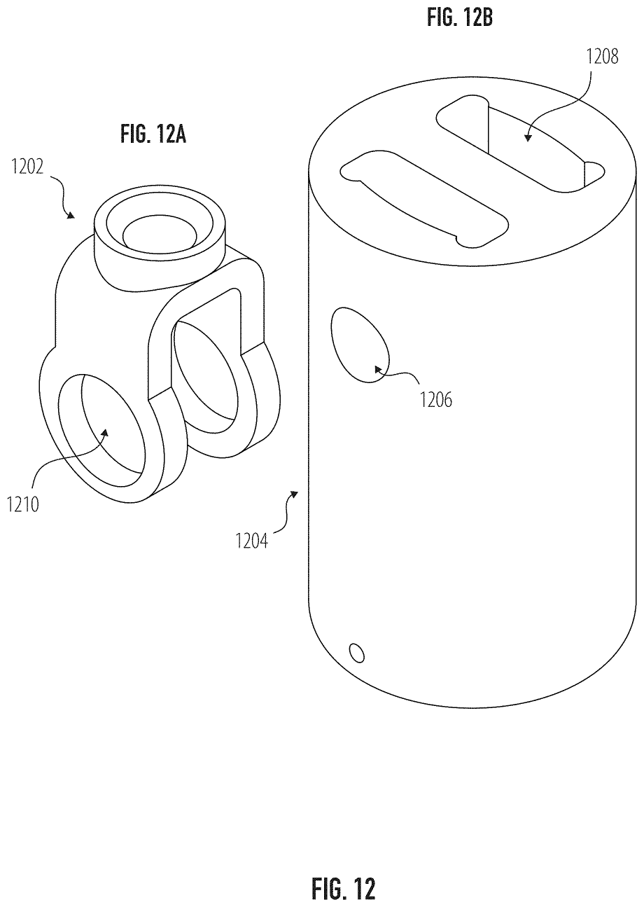

FIG. 12 is another illustration of the yoke 1002, the structural body 102, the pair of yoke-receiving channels 202, and the pin-receiving channel 110, wherein the yoke 1002 is a brake chamber yoke. In a method of installing or removing the yoke 1002 using the device of the present disclosure, as an initial step, the yoke 1002 is inserted into the pair of yoke-receiving channels 202.

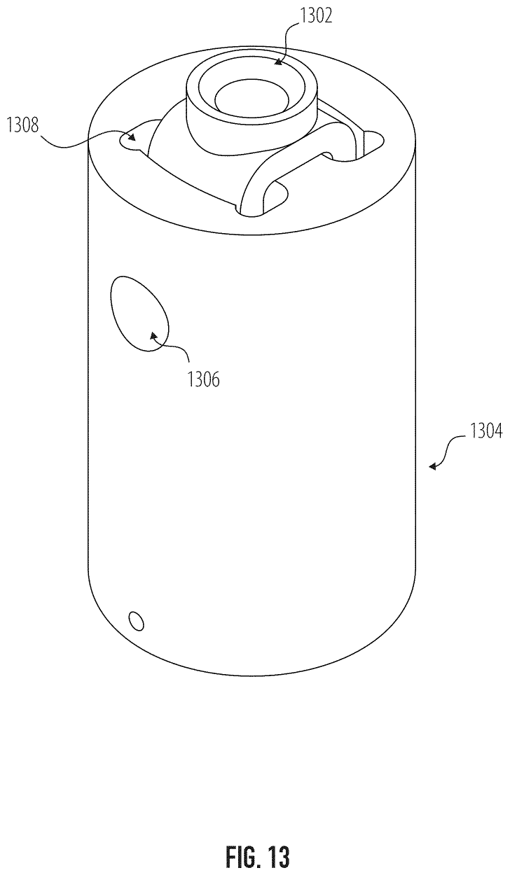

FIG. 13 is an illustration of when the yoke 1002 is inserted into the pair of yoke-receiving channels 202. The yoke 1002 is inserted such that the pair of pin holes 1004 of the yoke 1002, seen in FIG. 12, is concentrically aligned with the pin-receiving channel 110. If a safety pin is used, the safety pin may be inserted into the pin-receiving channel 1206 such that the safety pin, pin-receiving channel 1206, and the pair of pin holes 1210 are concentrically aligned to each other.

Referring to FIG. 11, after the yoke 1002 has been inserted into the pair of yoke-receiving channels 202, in a subsequent step of the method, an installation/removal tool 1402 is connected to the structural body 102 at the tool-receiving recess 104 shown in FIG. 1.

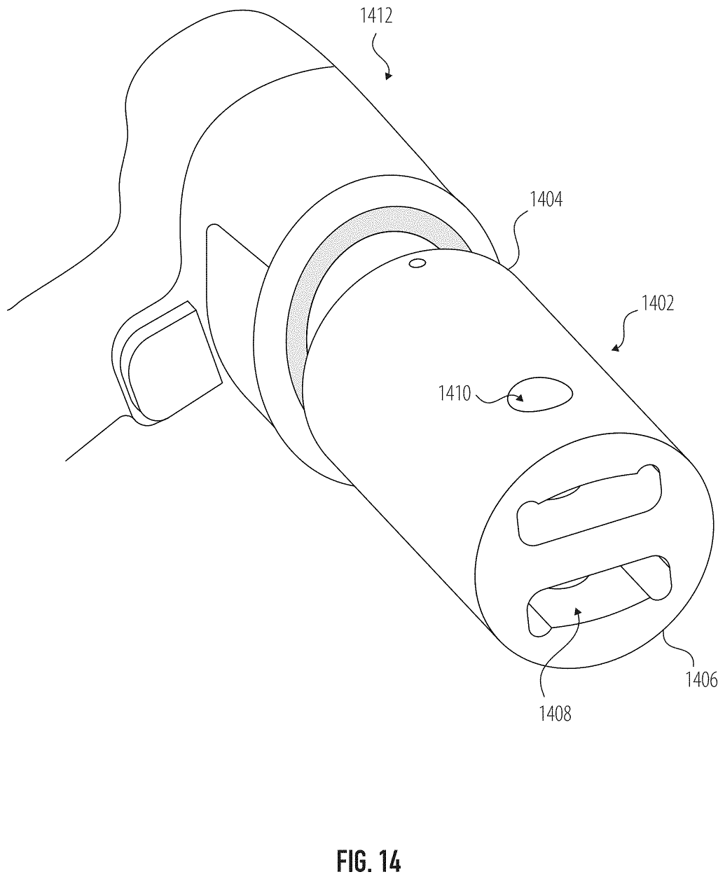

In one embodiment, as seen in FIG. 14, the installation/removal tool 1402 can be an impact wrench. In another embodiment, the installation/removal tool 1402 of FIG. 14 can be a manual ratchet. After the installation/removal tool 1402 is attached to the structural body 102, the user may proceed to install the yoke 1002 of FIG. 11 by activating the installation/removal tool 1402 to rotate the structural body 102 in a clockwise direction. In another aspect, the user may proceed to remove the yoke 1002 of FIG. 11 by activating the installation/removal tool 1402 to rotate the structural body 102 in a counterclockwise direction.

The yoke installation and removal assisting device of the present disclosure may be used to install a yoke onto or remove a yoke from a component that can be, but is not limited to, a driveshaft or a brake chamber. By utilizing the yoke installation and removal assisting device of the present disclosure, a yoke can be installed or removed conveniently with the use of an air tool or a manual ratchet.

The method of installing or removing a yoke using the device as described above, comprising the steps of: inserting a yoke into the pair of yoke-receiving channels, connecting an installation/removal tool to the structural body at the tool-receiving recess; concentrically aligning the pin-receiving channel with a pair of pin holes of the yoke; slidably positioning a safety pin into the pin-receiving channel and through the pair of pin holes to connect the yoke and structural body; and activating the installation/removal tool to rotate the structural body and the yoke in either a clockwise or counterclockwise direction.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A yoke installation and removal assisting device, said device comprising:
a structural body, said structural body having a length extending between a first end and a second end;
a pair of yoke-receiving channels traversing into said structural body at said first end and partially traverses through said length of said structural body; and
a tool-receiving recess centrally traversing into said structural body at said second end, wherein said structural body is rotated to remove or install said yoke.

2. The yoke installation and removal assisting device of claim 1, wherein said structural body is cylindrical in shape.

3. The yoke installation and removal assisting device of claim 1, wherein an overall cross-section of each of said pair of yoke-receiving slots is rectangular in shape.

4. The yoke installation and removal assisting device of claim 1, wherein said tool-receiving recess is cubical in shape.

5. The yoke installation and removal assisting device of claim 4, further comprising:
a first engagement cavity and a second engagement cavity in said tool-receiving recess;
said first engagement cavity traversing into a first lateral surface of said tool-receiving recess; and
said second engagement cavity traversing into a second lateral surface of the tool-receiving recess,
wherein said first lateral surface and said second lateral surface are positioned opposite to each other.

6. The yoke installation and removal assisting device of claim 1, further comprising:
a pin-receiving channel laterally traversing through said structural body adjacent said first end, wherein a safety pin is inserted into said pin-receiving channel and secured within said pin-receiving channel with a locking mechanism.

7. The yoke installation and removal assisting device of claim 6, wherein a cross-section of said pin-receiving channel is circular in shape.

8. The yoke installation and removal assisting device of claim 6, wherein said locking mechanism is a spring-loaded locking detent mechanism.

9. The yoke installation and removal assisting device of claim 6, wherein said locking mechanism is a magnetic locking mechanism.

10. The yoke installation and removal assisting device of claim 1, wherein said structural body is manufactured from tool steel.

11. The yoke installation and removal assisting device of claim 1, wherein said structural body is manufactured from carbon fiber.

12. The yoke installation and removal assisting device of claim 1, wherein said structural body is manufactured from aluminum.

13. A method of installing or removing a yoke using the device of claim 6, said method comprising the steps of:
inserting a yoke into said pair of yoke-receiving channels,
connecting an installation/removal tool to said structural body at said tool-receiving recess;
concentrically aligning said pin-receiving channel with a pair of pin holes of the yoke;
slidably positioning a safety pin into said pin-receiving channel and through said pair of pin holes to connect said yoke and structural body; and
activating said installation/removal tool to rotate said structural body and said yoke.

14. The method of installing or removing a yoke using the device of claim 13, wherein said structural body is rotated in a clockwise direction using said installation/removal tool to install said yoke.

15. The method of installing or removing a yoke using the device of claim 13, wherein said structural body is rotated in a counterclockwise direction using said installation/removal tool to remove said yoke.

16. The method of installing or removing a yoke using the device of claim 13, wherein said installation/removal tool is an impact wrench.

17. The method of installing or removing a yoke using the device of claim 13, wherein said installation/removal tool is a manual ratchet.
